(19) United States
(12) Patent Application Publication
(10) Pub. No.: US 2001/0023711 A1
(43) Pub. Date: Sep. 27, 2001

(54) Manual fuel supply tap with reserve position

(75) Inventor: Antonio Gnudi, Bologna (IT)

Correspondence Address: MODIANO & ASSOCIATI, Via Meravigli, 16, MILANO, 20123, IT

(73) Assignee: PAIOLI S.p.A.

(21) Appl. No.: 09/810,439

(22) Filed: Mar. 19, 2001

(30) Foreign Application Priority Data
Mar. 23, 2000 (IT) B02000U000045

(51) Int. Cl. F16D 1/08; F16K 11/074

(52) U.S. Cl. 137/590

(57) ABSTRACT

A manual fuel supply tap with reserve position, comprising a tap body which has a cylindrical blind hole in the bottom of which a front distribution unit is mounted rotatably and hermetically, the distribution unit being provided with a stem which is associated with a manual actuation handle, a washer being fitted along the actuation stem, being provided with means which allow its relative axial sliding but not its rotation, and having at least one raised tooth which is adapted to cooperate with a corresponding notch of a fixed ring for closing the blind hole against which it is pressed by elastic means in order to determine the reserve position.

### BACKGROUND OF THE INVENTION

The present invention relates to a manual fuel supply tap with reserve position.

Conventional manual fuel supply taps with reserve position are constituted by a tap body crossed by ducts which lead respectively to the engine and to the fuel tank at a normal operating level and at the reserve level: a flow control element is rotatably fitted inside the tap body and has openings which, by way of the rotation of the flow control element achieved by means of an actuation handle, connect the motor to the opening, reserve, and closure positions: conventional taps have flow control elements which are conical or disk-like, and in this last case the duct inlet connection opening is constituted by a slot which is formed in a face of the flow control element that is directed toward the inlet of said ducts.

Conventional manual fuel supply taps with reserve position have drawbacks in relation to the correct actuation of the tap handle, which does not provide clearly detectable indications that the reserve position has been reached. In practice, when the user is traveling and has to select the reserve position, he has to proceed in rather unstable environmental conditions and cannot check visually that he has reached the intended reserve condition: one must not forget that this operation is often performed while the vehicle is moving and that the tap is usually located in positions which are not directly visible.

### SUMMARY OF THE INVENTION

The aim of the present invention is to obviate the above-cited drawbacks, by providing a manual fuel supply tap with reserve position which ensures that the reserve position is correctly reached.

Within this aim, an object of the present invention is to provide a tap which is simple, relatively easy to provide in practice, safe in use, effective in operation and has a relatively low cost.

This aim and this and other objects which will become better apparent hereinafter are achieved by a manual fuel supply tap with reserve position according to the present invention, constituted by a tap body which has a cylindrical blind hole in the bottom of which there end ducts which lead to an engine and, at an operating level and at a reserve level, to a fuel tank, a front distribution unit being mounted rotatably and hermetically in said body and being provided with a stem which is associated with a manual actuation handle which, by rotation, is adapted to selectively connect inlets of the duct that leads to the engine and opening, reserve and closure inlets, wherein a washer is fitted along said actuation stem, is provided with means which allow only its relative axial sliding, and has at least one raised tooth which is adapted to cooperate with a corresponding notch of a fixed ring for closing said blind hole against which it is pressed by elastic means in order to determine the reserve position.

### BRIEF DESCRIPTION OF THE DRAWINGS

Further characteristics and advantages of the present invention will become better apparent from the following detailed description of a preferred but not exclusive embodiment of a manual fuel supply tap with reserve position according to the invention, illustrated only by way of non-limitative example in the accompanying drawings, wherein:

FIG. 1 is an exploded sectional side view, taken along a diametrical plane, of the components of a manual fuel supply tap with reserve position according to the invention;

FIGS. 2, 3 and 4 are respectively a front view and sectional orthographic projections views, taken along diametrical planes, of the washer of the tap according to the invention;

FIGS. 5 and 6 are respectively a front view and a sectional side view of the lower closure ring of the tap.

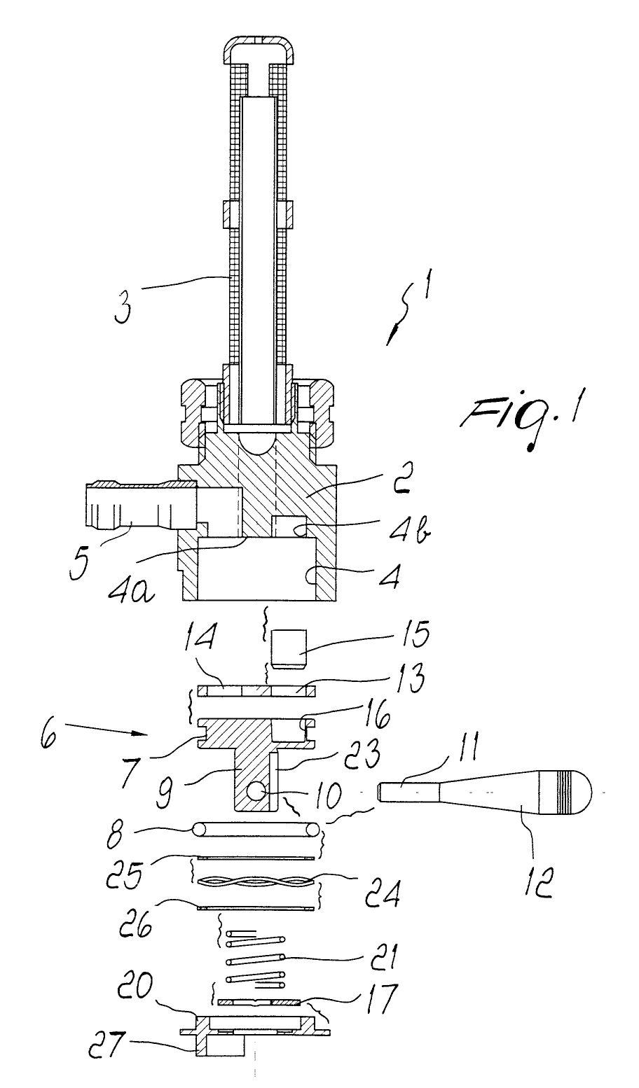

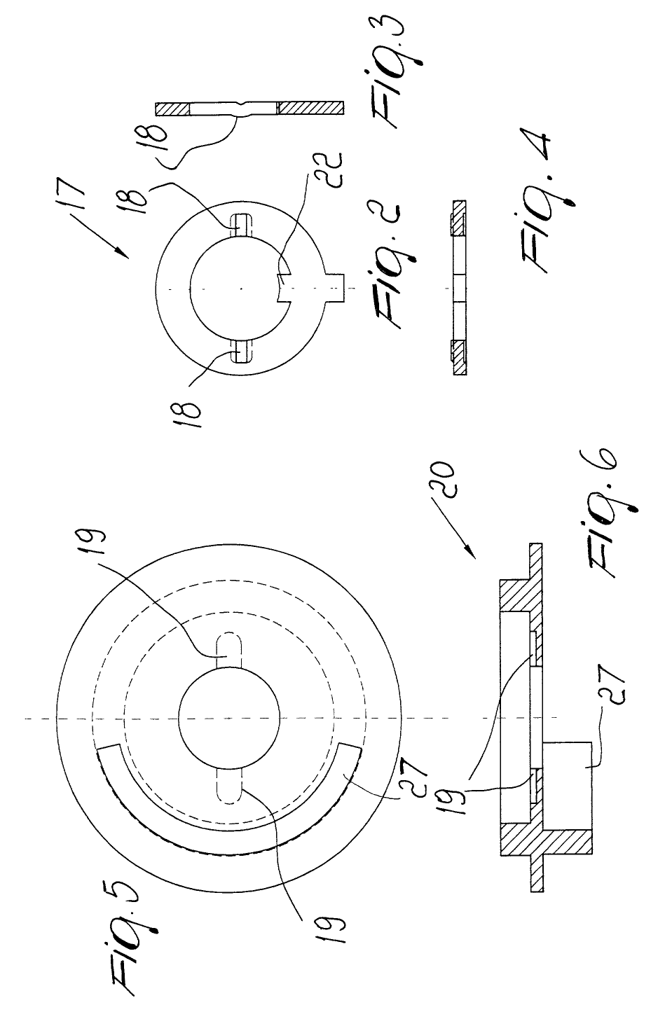

### DESCRIPTION OF THE PREFERRED EMBODIMENTS

With particular reference to the figures, the reference numeral 1 generally designates a manual fuel supply tap with reserve position according to the invention.

The tap 1 is constituted, in a substantially known manner, by a tap body 2 on top of which a filter 3 is mounted; the filter has, in a downward region, a cylindrical blind hole 4, in the bottom 4a of which there end ducts which lead to the motor 5 and, at an operating level and at the reserve level, to the fuel tank (the ducts are not shown in the figure), and a cylindrical blind recess 4b.

A front distribution unit 6 is rotatably and hermetically fitted in the blind hole 4 and is shaped like a cylindrical plate with a peripheral annular recess 7 for a toroidal sealing ring of the type known as O-ring, with an axial stem 9 crossed by a diametrical hole 10 for the insertion and fixing of the end 11 of a manual actuation handle 12.

A disk-like gasket 13 is interposed between the distribution unit 6 and the bottom 4a of the hole 4 and is advantageously made of a material of the type known by the trade-name Teflon; four holes 14 are distributed therein and are meant to align with the openings of the bottom of the hole 4: a bush 15 can be inserted in the recess 4b and enters one of the holes 14 in order to lock the gasket with respect to the body 2.

An arc-shaped slot 16 is formed on the face of the distribution unit 6 that is directed toward the bottom 4a, covers substantially 90 degrees and is adapted to selectively connect to each other, by way of the rotation of the distribution unit, the inlet of the duct that leads to the engine and the opening, reserve and closure inlets.

A washer 17 is fitted along the stem 9 and has, in the practical embodiment shown in the figure, two protruding teeth 18 which are meant to cooperate with two corresponding notches 19 of a closure ring 20 which is fixed by interference fit on the inlet of the blind hole; the washer 17 is pressed against the ring 20 by elastic means 21 which are constituted by a helical compression spring in order to determine the reserve position.

Means are provided which allow the relative axial sliding, but not the rotation, of the washer 17 along the stem 9; such means are constituted by a radial lip 22 which is substantially rectangular, protrudes toward the inside of the hole of the washer 17 and enters a corresponding longitudinal slot 23 of the stem.

The number of teeth of the washer and the number of notches of the closure ring can be other than two.

A leaf spring 24 and two deformable sealing washers 25 and 26, advantageously made of a material of the type known by the trade-name Teflon, are packed between the closure ring 20 and the lower perimetric surface of the distribution unit 6.

The closure ring 20 has an outer crest 27 which runs substantially along half a circumference and is adapted to act as a stroke limiter for the rotation of the handle 12.

The operation of the invention is self-evident: by way of the interference between the teeth 18 and the notches 19, the position of the reserve is detected assuredly without having to actually see the arrangement of the handle 12; moreover, the assembly of the components and the tightness of the assembly are simplified and improved.

It has thus been observed that the invention achieves the intended aim and object.

The invention thus conceived is susceptible of numerous modifications and variations, all of which are within the scope of the inventive concept.

All the details may further be replaced with other technically equivalent ones.

In practice, the materials used, as well as the shapes and dimensions, may be any according to requirements without thereby abandoning the scope of the protection of the appended claims.

The disclosures in Italian Utility Model Application No. BO2000U000045 from which this application claims priority are incorporated herein by reference.

What is claimed is:

1. A manual fuel supply tap with reserve position, comprising a tap body which has a cylindrical blind hole in a bottom of which there end ducts which lead to an engine and, at an operating level and at a reserve level, to a fuel tank, a front distribution unit being mounted rotatably and hermetically in said body and being provided with a stem which is associated with a manual actuation handle which, by rotation, is adapted to selectively connect inlets of the duct that leads to the engine and opening, reserve and closure inlets, wherein a washer is fitted along said actuation stem, is provided with means which allow only its relative axial sliding, and has at least one raised tooth which is adapted to cooperate with a corresponding notch of a fixed ring for closing said blind hole against which it is pressed by elastic means in order to determine the reserve position.

2. The tap according to claim 1, wherein said means that allow only the relative axial sliding, but not the rotation, of said washer are constituted by a radial lip which protrudes toward the inside of the hole of the washer and enters a corresponding longitudinal slot of said stem.

3. The tap according to claim 1, wherein at least one tooth of the washer and the corresponding notch of the closure ring are two and are diametrically opposite.

4. The tap according to claim 1, wherein said ring for closing the blind hole has an external crest which substantially covers half of a circumference which is adapted to act as a stroke limiter for the rotation of said handle.

5. The tap according to claim 1, wherein a leaf spring and two deformable sealing washers are packed between said blind hole closure ring and said front distribution unit.
